(19) United States
(12) Patent Application Publication
(10) Pub. No.: US 2012/0193329 A1
(43) Pub. Date: Aug. 2, 2012

(54) POWDER MICRO-SPARK DEPOSITION SYSTEM AND METHOD

(76) Inventors: YONG LIU, Shanghai (CN); Yingna Wu, Shanghai (CN); Guoshuang Cai, Shanghai (CN); Xiaobin Chen, Shanghai (CN); Yanmin Li, Shanghai (CN)

(21) Appl. No.: 13/359,973

(22) Filed: Jan. 27, 2012

(30) Foreign Application Priority Data
Jan. 30, 2011 (CN) 201110032999.4

(51) Int. Cl. B23K 9/04

(52) U.S. Cl. 219/76.13

(57) ABSTRACT

A powder micro-spark deposition system is provided. The deposition system includes an electrode and a powder feed channel configured within or at least partially surrounding the electrode for guiding powder comprising electrically conductive material into a gap between the electrode and the substrate. A powder micro-spark deposition method is also provided.

### BACKGROUND

The present invention relates generally to surface enhancement technologies, and, more specifically, to a micro-spark deposition (MSD) system and method.

MSD is a pulsed-arc micro-welding process that uses short-duration, high-current electrical pulses to deposit a consumable electrode material on a metallic substrate. As pulse durations of a few microseconds combined with pulse frequencies in the 0.1 kilohertz to 4 kilohertz range allow substrate heat dissipation over approximately 99% of the duty cycle, the MSD process, with very low heat-input, is distinguished from other arc welding processes. MSD offers a particular advantage when coating or repairing materials considered difficult to weld because of heat-affected-zone (HAZ) issues.

In a typical conventional MSD process, as shown in FIG. 1, an electrode 12 made from the coating material serves as a consumable anode, while the substrate 14 to be deposited serves as a cathode. Striking an arc between the electrode 12 and the substrate 14 causes some of the electrode material to melt instantaneously at the point of contact and deposit on the surface of the substrate 14 to form a coating 16. Since the electrode 12 needs to contact the surface of the substrate 14, the discharging gap (air gap) between the electrode 12 and the substrate 14 is very small. The small discharging gap constrains the thickness of the coating. Additional challenges affecting conventional MSD processes include low deposition rates and difficulty with controlling the processing and providing uniform coating thickness.

A powder mixed MSD process was recently described in an article titled “Electrospark Deposition by using Powder Materials” published in Materials and Manufacturing Processes, 25: 932-938, 2010, wherein powder is introduced into the discharging gap between the electrode and the substrate. Conductive powder is fed from a side of the gap, and the captured powder can be ionized and transferred to the substrate surface to form a deposition layer. However, as the powder is delivered to the gap from one side thereof, the powder capture efficiency is expected to be low because the powder is difficult to introduce in the very small gap from a side. Moreover, for the described MSD process appears to require a powder-feeding nozzle to adjust the relative position of the nozzle tip and the electrode due to consumption of electrode, and the powder feeding nozzle is selected to increase the difficulty of operation and thus of process automatization.

Therefore, there is a need for a new and improved MSD system and method.

### BRIEF DESCRIPTION

One aspect of the present disclosure is a powder micro-spark deposition (PMSD) system comprising an electrode for depositing material onto a substrate by electric spark deposition, and a powder feed channel configured within or at least partially surrounding the electrode for guiding powder comprising electrically conductive material into a discharging gap between the electrode and the substrate.

Another aspect of the present disclosure is an electrode comprising an electrode rod for depositing material onto a substrate by electric spark deposition, and a powder feed channel configured within the electrode rod for guiding powder comprising electrically conductive material into a discharging gap between the electrode and the substrate.

Another aspect of the present disclosure is a PMSD method comprising depositing materials onto a substrate through an electrode by electric spark deposition while feeding powder comprising electrically conductive material into a discharging gap between the electrode and the substrate from a powder feed channel configured within or surrounding the consumable electrode.

### BRIEF DESCRIPTION OF THE DRAWINGS

The above and other aspects, features, and advantages of the present disclosure will become more apparent in light of the subsequent detailed description when taken in conjunction with the accompanying drawings in which:

FIG. 1 is a schematic diagram of an exemplary conventional micro-spark deposition system;

FIG. 2 is a schematic diagram of a powder micro-spark deposition system in accordance with one embodiment of the present disclosure;

FIG. 3 is a schematic diagram of a powder micro-spark deposition system in accordance with another embodiment of the present disclosure;

FIG. 4 is a schematic diagram of a powder micro-spark deposition system in accordance with another embodiment of the present disclosure;

FIG. 5 is a schematic diagram of a powder micro-spark deposition system in accordance with another embodiment of the present disclosure;

FIG. 6 illustrates an exemplary closed-loop control schematic of a control system in accordance with one embodiment of the present disclosure;

FIG. 7 is a schematic diagram of a control apparatus in accordance with one embodiment of the present disclosure;

FIG. 8 illustrates a comparison of discharge ratio proportion between a coaxial feeding deposition and a sideward feeding system in accordance with an example of the present disclosure;

FIG. 9 is a cross sectional diagram of an electrode in accordance with an example of the present disclosure;

FIG. 10 is a schematic diagram of a powder micro-spark deposition system in accordance with an example of the present disclosure;

FIG. 11 is a cross sectional diagram taken through the plane A-A of FIG. 10; and

FIG. 12 is a cross sectional diagram taken through the plane B-B of FIG. 11.

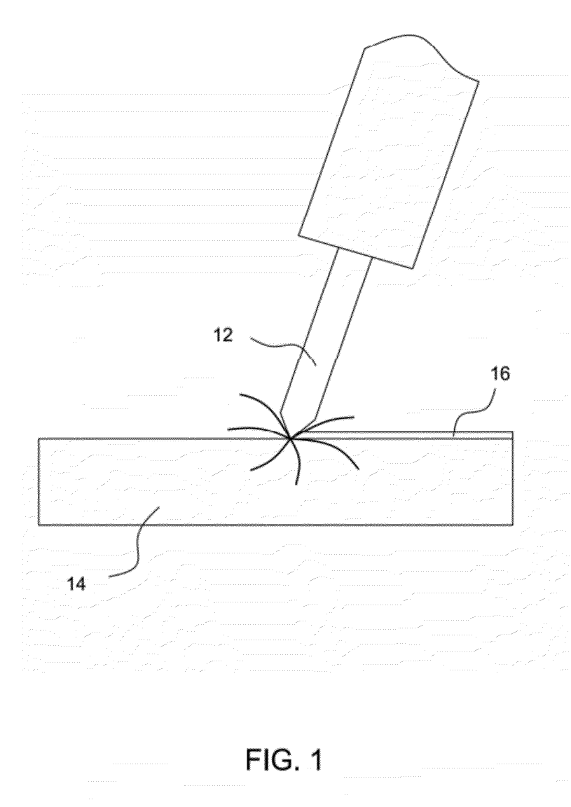

### DETAILED DESCRIPTION

Embodiments of the present disclosure will be described hereinbelow with reference to the accompanying drawings. In the subsequent description, well-known functions or constructions are not described in detail to avoid obscuring the disclosure in unnecessary detail.

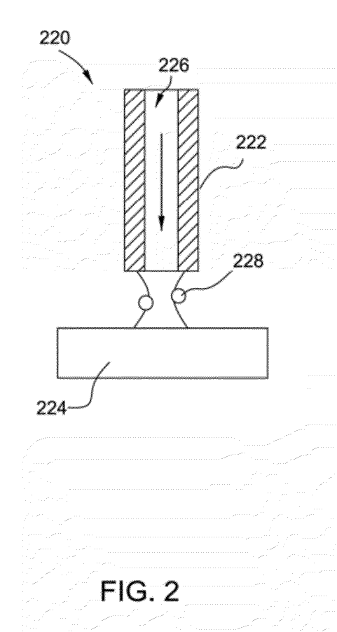

In one aspect of the present disclosure, a powder micro-spark deposition (PMSD) system is provided. The PMSD system comprises an electrode for depositing a coating onto a substrate by electric spark deposition. The PMSD further comprises a powder feed channel within or at least partially surrounding the electrode for guiding powder comprising electrically conductive material into a discharging gap between the electrode and the substrate. Embodiments of the PMSD system will be described as examples hereinbelow with reference to FIGS. 2-5.

Referring to FIG. 2, in the illustrated embodiment, a PMSD system 220 comprises an electrode 222 for depositing a coating onto a substrate 224 by electric spark deposition and a powder feed channel 226 configured within the electrode 222 for guiding powder 228 comprising electrically conductive material into a discharging gap between the electrode 222 and the substrate 224. In such a PMSD system, the powder 228 is fed into the discharging gap in a direction substantially coaxial with respect to the electrode 222 and therefore a high powder capture efficiency can be achieved.

The powder feed channel 226 within the electrode 222 may comprise any structurally suitable type of channel with several examples including, for example, holes, slots, and annular grooves. For example, in one embodiment, the powder feed channel 226 comprises a hole configured within the electrode and axially cutting through two longitudinal ends of the electrode. The powder feed channel 226 need not be constant in form or dimensions along the entire longitudinal direction of the electrode 222, and different longitudinal sections of the electrode 222 may be formed with different cross sections. For example, a powder feed channel may comprise a hole in a first longitudinal section of the electrode and a plurality of grooves and/or slots in a second longitudinal section of the electrode in communication with the hole.

Either the electrode or powder, or both of them may comprise materials suitable for deposition and for the intended purpose of a particular coating. Several non-limiting examples of potential electrode materials include copper, stainless steel, nickel based alloys, tungsten, graphite, and combinations thereof. Several non-limiting example of powder materials include stainless steel, nickel based alloys, and nickel coated Al₂O₃, and combinations thereof. If desired, graded and composite coatings may be deposited by choosing different materials of electrode and powder and controlling the powder feeding rate, for example.

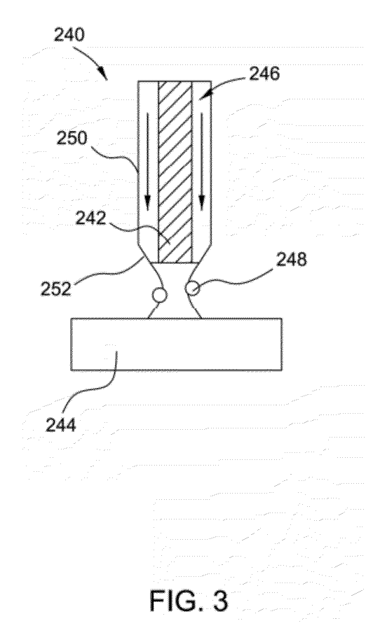

Referring to FIG. 3, in the illustrated embodiment, a PMSD system 240 comprises an electrode 242 for depositing a coating onto a substrate 244 by electric spark deposition, and a powder feed channel 246 at least partially surrounding the electrode 242 for guiding powder 248 comprising electrically conductive material into a discharging gap between the electrode 242 and the substrate 244. In one specific embodiment, the powder is fed into the discharging gap from a circle surrounding a tip of the electrode in different directions and therefore a high powder capture efficiency can be achieved.

The powder feed channel 246 may comprise a channel in various forms with some of those forms including a channel or series of channels that substantially surrounds the electrode 242, such as an annular groove, one or more, openings, or the like. For example, in one embodiment, the PSMD system 240 comprises an annulus 250 surrounding the electrode 242, and the powder feed channel 246 may be an annular groove defined between an inner surface of the annulus 250 and an external surface of the electrode 242. In a more specific but related embodiment, the annulus 250 comprises a radially inwardly chamfered end 252 configured to guide the powder 248 to flow radially inward into the gap between the electrode 242 and the substrate 244.

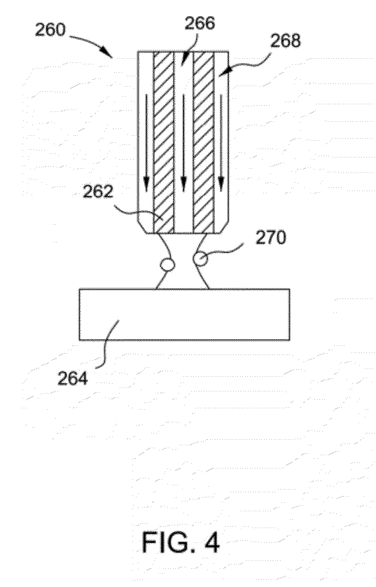

In certain embodiments, the PMSD system as described hereinabove may comprise two or more powder feed channels either configured within the electrode, around the electrode, or both. For example, as illustrated in FIG. 4, a PMSD system 260 comprises an electrode 262 comprising material depositable onto a substrate 264 by electric spark deposition, a first powder feed channel 266 configured within the electrode 262 and a second powder feed channel 268 at least partially surrounding the electrode 262, both for guiding powder 270 comprising electrically conductive material into a discharging gap between the electrode 262 and the substrate 264. For example, the first powder feed channel 266 may comprise at least one channel in various forms configured within the electrode 262, and the second powder feed channel 268 may comprise at least one channel that at least in part surrounds the electrode 262.

In some embodiments, a PMSD system may comprise combinations of types of powder feed channels. For example, in one embodiment, a PMSD system comprises a center hole and an annular groove, both configured within the electrode and axially cutting through two longitudinal ends of the electrode. In another embodiment, a PMSD system comprises a plurality of holes axially parallel configured within the electrode and an annular groove at least partially surrounding a peripheral surface of the electrode.

Moreover, besides the powder feed channels, the PMSD system as described hereinabove may further comprise one or more powder feed structures for use in providing additional sources of powder or guiding the direction of the powder feed.

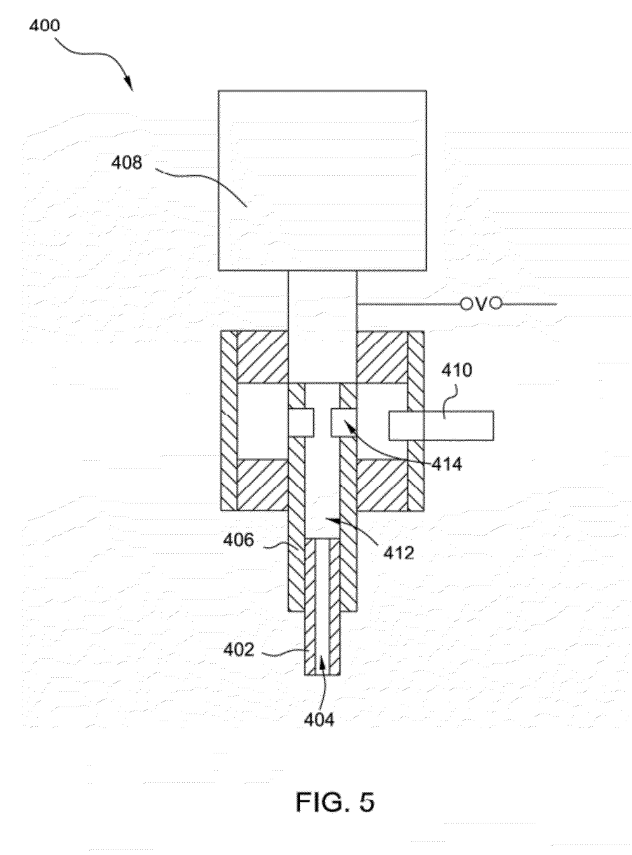

In certain embodiments, the PMSD system as described hereinabove further comprises an electrode holder for detachably holding the electrode, an actuator for moving and/or controlling the electrode holder, and a powder feeder for feeding powder to the powder feed channel. For example, as illustrated in FIG. 5, a PMSD system 400 comprises an electrode 402, a powder feed channel 404, an electrode holder 406, an actuator 408 and a powder feeder 410. The electrode holder 406 comprises a powder feed passage 412 communicating with the powder feed channel 404, and a powder inlet 414 communicating with the powder feed passage 412, for receiving powder from the powder feeder 410. The powder feeder 410 is connected to the powder inlet 414 for feeding powder into the powder feed channel 404 through the powder feed passage 412. In one embodiment, the actuator 408 is a CNC Z-axis device. In one embodiment, the powder is carried by gas flow and the carrier gas can be either reactive gases, such as oxygen, or inert gases, such as argon.

In certain embodiments, the PMSD system as described hereinabove further comprises a control system applied to enable automatic PMSD process.

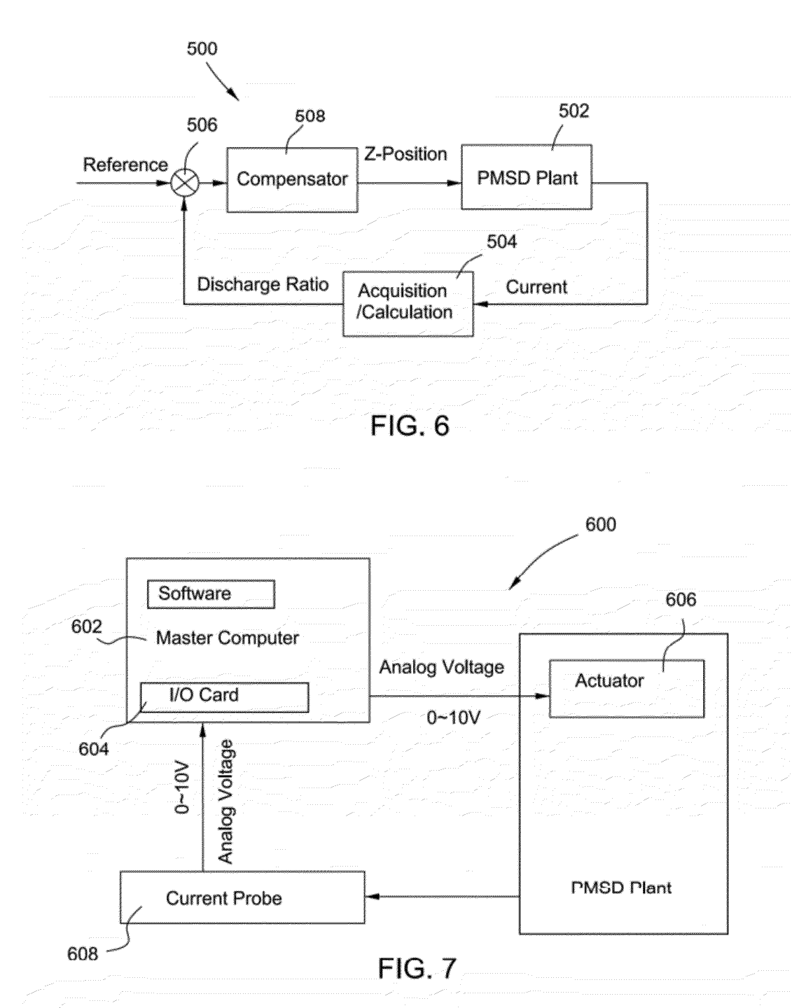

FIG. 6 illustrates an exemplary closed-loop control schematic of a control system 500 for a PMSD process. The PMSD Plant block 502 represents a PMSD process, from which the input data including position of an actuator and the output data including current are measurable for process analysis and control. In the illustrated embodiment, the control system 500 comprises an Acquisition/Calculation module 504, an accumulator module 506, and a Compensator module 508. The Acquisition/Calculation module 504 is applied to acquire data of current from the PMSD Plant block 502 and to calculate discharge ratio based on the acquired current data. The accumulator module 506 is applied to compare the discharge ratio calculated by the Acquisition/Calculation module 504 with a reference value. The Compensator module 508 is applied to adjust the position of the actuator and thereby to control the discharging gap between the electrode and substrate. The Acquisition/Calculation module may be implemented by a series of software and hardware. The Compensator module may be implemented by software in a PC-based control system, for example.

In an illustrated embodiment as shown in FIG. 7, a control apparatus 600 comprises both hardware and software. In one embodiment, the hardware comprises a system master computer 602 installed with a PCI multi-function I/O card 604. The card 604 has 8 high-speed 12-bit analog input channels, one of which is used to acquire power supply current signal of the PMSD system, and 2 analog output channels, one of which is used to transfer a signal to the actuator 606 to control movement of the electrode holder. The hardware further comprises a current probe 608 that is used to convert a current signal from the PMSD plant to voltage signal. In one embodiment, Microsoft Visual C++ is used to program software for the control apparatus. The software may include several modules, such as user interface, data acquisition, calculation, and control algorithms, for example. In one embodiment, a proportional-integral-derivative controller (PID controller) is used to correct the error between a measured process variable and a desired set point by calculating and then outputting a corrective action to adjust the process accordingly.

In another aspect of the present disclosure, a powder micro-spark deposition method is provided. The deposition method comprises: depositing materials onto a substrate through an electrode by electric spark deposition while feeding powder comprising electrically conductive material into a discharging gap between the electrode and the substrate from a powder feed channel configured within or at least partially surrounding the consumable electrode. In one embodiment, the powder is carried by gas flow and injected into the discharging gap, and the carrier gas may comprise either reactive gases, such as oxygen, or inert gases, such as argon.

During deposition, the electrode acts as an anode while the substrate acts as a cathode. The powder injected into the gap between electrode and the substrate acts as series particle electrodes, and the ionized material from the electrode and ionized powder is transferred to the substrate surface to a deposited layer on the substrate. The deposited layer has a metallurgical adherence on the impregnated or alloyed substrate.

With powder addition, the discharging gap between the electrode and the substrate can be increased, and thus electrode wear can be decreased. Additionally, embodiments of the present invention are expected to provide more uniform discharge so that surface roughness may be decreased.

In certain embodiments, a distance between the electrode and the substrate is in a range of 20-200 μm. In more specific embodiments, the distance is in a range of 20-100 μm. In certain embodiments, a flow rate of the powder fed into the discharging gap is in a range of 1-2 g/min. In more specific embodiments, the flow rate of the powder is in a range of 1-1.5 g/min. In certain embodiments, a voltage across the discharging gap is in a range of 50-150V. In more specific embodiments, the voltage in a range of 100-150V. In certain embodiments, a capacitance for spark discharging is in a range of 100-200 μF. In more specific embodiments, the capacitance is in a range of 100-160 μF. In certain embodiments, a flow rate of powder carrier gas is in a range of 5-15 l/min. In more specific embodiments, the flow rate of powder carrier gas is in a range of 5-10 l/min.

The powder micro-spark deposition may be operated in open air environment, in oil or other mediums.

In the PMSD system and method as described hereinabove, consumption of the electrode may be substantially reduced or, in some embodiments if sufficient powder is used, even avoided. In certain embodiments, when the electrode and the powder are made from different materials and the powder material is intended to be deposited rather than the electrode material, the electrode may be coated with the powder material to avoid contamination from the electrode material.

As comparing with deposition systems or methods in which powder is fed into the discharging gap from one side thereof, the PMSD system as described herein may be used to provide higher powder capture efficiency as well as a more stable discharge process. Furthermore, embodiments described herein are automatized and become simpler to operate due to having no need of alignment between an electrode and a powder feed apparatus.

### Example 1

In Example 1, experiments are carried out to compare discharge ratios between a sideward feeding deposition system like that as described in the aforementioned article of “Electrospark Deposition by using Powder Materials” and a coaxial feeding deposition system as shown in FIG. 2. A solid copper electrode with an nickel based super alloy (Inconel 718 (IN718)) coating at the tip thereof is used in the sideward feeding deposition system, while a hollow copper electrode with an outer diameter of 5 mm and an inner diameter of 2 μm is used in the coaxial feeding deposition system of FIG. 2, to deposit IN718 powder with particle size of 45-75 um onto a IN718 coupon 25 mm in diameter and 3 mm in thickness.

The experiments are performed at same process conditions as follows:

Voltage: 100V, Resistance-capacitance (RC) power supply

Capacity: 160 uF

Frequency: 260 Hz

Scanning speed: 2 mm/s

Powder feeding rate: 1 g/min

Rotating speed of electrode: 1000 r/min

Gas flow rate: 5 L/min.

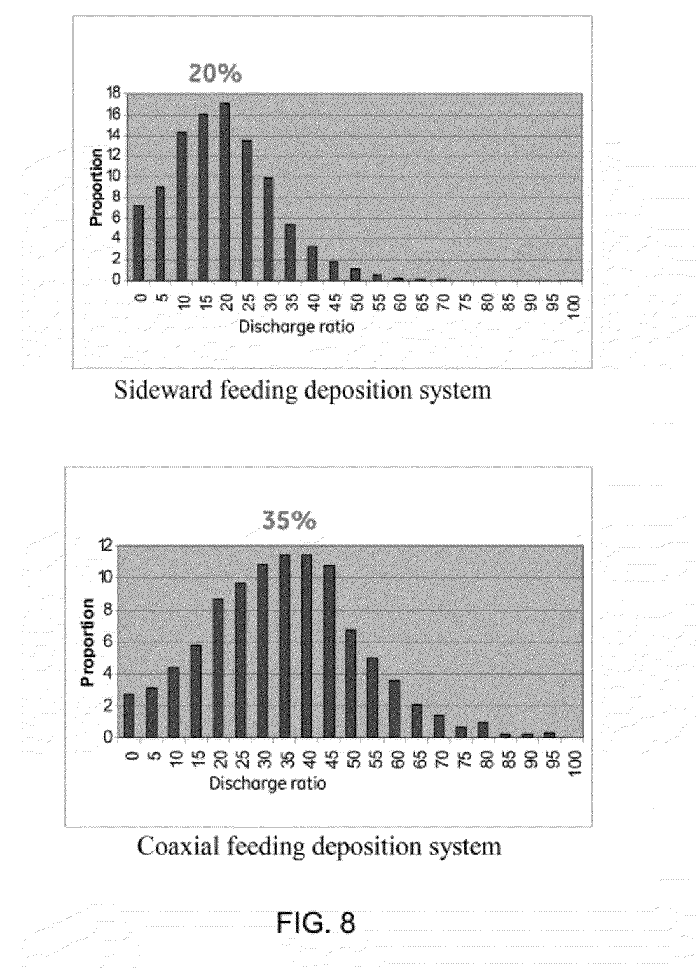

FIG. 8 provides a comparison of discharge ratios of the coaxial feeding deposition and the sideward feeding system. The Proportion indicator on the Y axis refers to the percentage of pulses at different discharge ratios. The more pulses that are concentrated in set point zone, the better the control performance. As shown in FIG. 8, as to the coaxial feeding deposition system, the peak of the curve with about 11% of pulses reaching discharge ratio of 30%, nearly 12% of pulses reaching discharge ratio of 35%, nearly 12% of pulses reaching discharge ratio of 40%, and about 11% of pulses reaching discharge ratio of 45%, illustrates that most of pulses are concentrated around a discharge ratio of 35%. In contrast, for the sideward feeding system, the curve peak concentrated around discharge ratio of 20%. A deposition rate of the coaxial feeding deposition system is about 8.9 mg/min at a discharge ratio of 35% which is higher than that of the sideward feeding system ratio of about 7.0 mg/min at a discharge ratio of 20%. Thus it can be seen that, due to a higher powder capture efficiency, the coaxial feeding deposition system can obtain a higher discharge ratio and thereby provide a higher deposition rate.

### Example 2

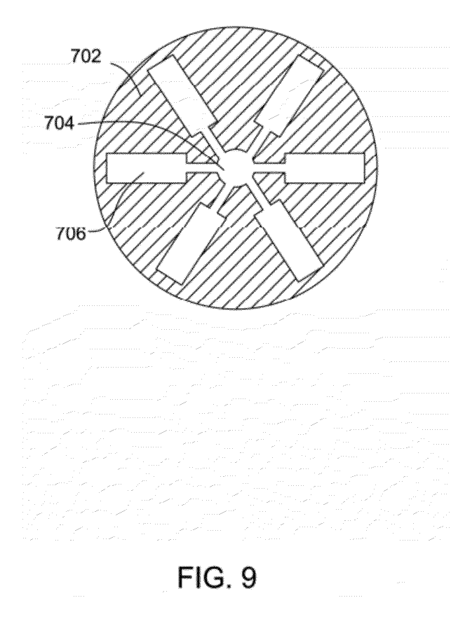

In Example 2, a PMSD system comprising a large scale electrode with multiple channels for feeding powder is tested. An electrode 702 with a cross sectional view as shown in FIG. 9 is used. The electrode 702 is 12 mm in diameter and is configured with a central hole 704 and a plurality of slots 706 radially around the central hole 704, all of which cut through longitudinal ends of the electrode 702, for delivering the powder to be fed into the discharging gap. The deposition test is performed at conditions as follows:

Voltage: 100V

Capacity: 140 μF;

Frequency: 700 Hz;

Powder feeding rate: 1 g/min;

Scanning speed: 1 mm/s;

Rotating speed of electrode: 1000 r/min

Gas flow rate: 5 l/min.

In this embodiment, the deposition rate is about 14 mg/min, which is faster than the embodiment of Example 1.

### Example 3

In Example 3, feasibility of a PMSD system in an electrode that is not consumable is tested. A copper electrode is used to deposit a nickel-based super alloy (Inconel 718 (IN718)) powder to an IN718 substrate, and copper contamination inside the IN718 coating is measured.

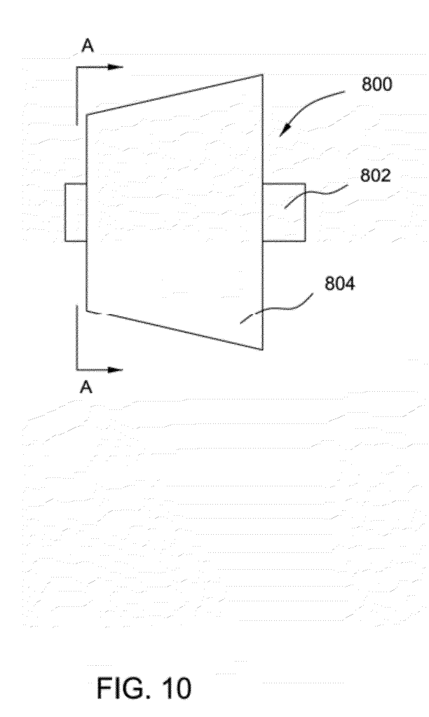

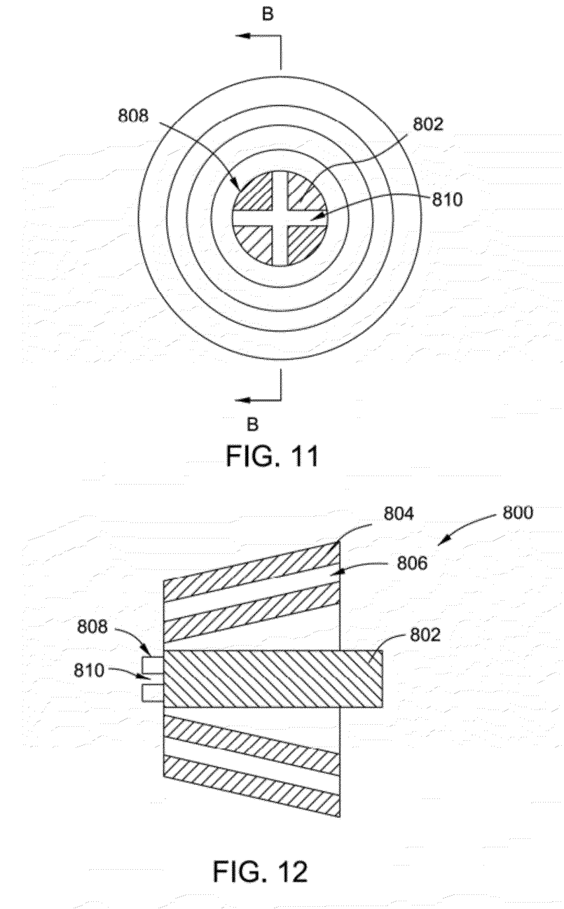

As illustrated in FIGS. 10-12, a PMSD system 800 comprises a copper electrode 802 and a cone rim 804, which defines an annular powder-feeding groove 806 surrounding the electrode 802. The copper electrode 802 comprises a tip section 808 configured with a cross slot 810 for guiding the powder from the groove 806 towards the center of the discharging gap to increase the powder capture efficiency. The tip section 808 is pre-deposited with IN718 coating with a thickness of 50 μm. The test for the PMSD system 800 is performed at conditions as follows:

Voltage: 100V

Capacity: 100 uF

Frequency: 260 Hz

Scanning speed: 1 mm/s

Powder feeding rate: 1 g/min

Rotating speed of electrode: 1000 r/min

Gas flow rate: 5 l/min.

The Cu contamination detected by X-ray fluorescence testing in the IN718 coating deposited by this process is only 0.01 wt %.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the subsequent claims.

What is claimed is:

1. A powder micro-spark deposition system, comprising:
an electrode for depositing a coating onto a substrate by electric spark deposition; and
at least one powder feed channel configured within or at least partially surrounding the electrode for guiding powder comprising electrically conductive material into a discharging gap between the electrode and the substrate.

2. The system of claim 1, wherein the electrode comprises a material depositable onto the substrate.

3. The system of claim 1, wherein the powder feed channel comprises a through hole formed within the electrode and extending through longitudinal ends of the electrode.

4. The system of claim 1, further comprising an annulus surrounding the electrode, wherein the powder feed channel comprises an annular groove defined between the annulus and the electrode.

5. The system of claim 4, wherein the annulus comprises a radially inwardly chamfered end configured to guide the powder flow radially inward into the discharging gap between the electrode and the substrate.

6. The system of claim 1, further comprising an electrode holder for detachably holding the electrode, wherein the electrode holder comprises a powder feed passage communicating with the powder feed channel and a powder inlet communicating with the powder feed passage for receiving the powder from a powder feeder.

7. The system of claim 6, wherein the electrode holder further comprises an actuator for adjusting the position of the electrode.

8. The system of claim 6, further comprising a control system for controlling the actuator and the powder feeder.

9. An electrode comprising:
an electrode rod for depositing a coating onto a substrate by electric spark deposition; and
a powder feed channel configured within the electrode rod for guiding powder comprising electrically conductive material into a discharging gap between the electrode and the substrate.

10. The electrode of claim 9, wherein the electrode comprises a main section and a tip section along a longitudinal direction, and wherein a cross section of the powder feed channel in the main section of the electrode is different from a cross section of the powder feed channel in the tip section of the electrode.

11. The electrode of claim 9, wherein the electrode is coated with the powder material.

12. A powder micro-spark deposition method, comprising:
depositing materials onto a substrate through an electrode by electric spark deposition, while
feeding powder comprising electrically conductive material into a discharging gap between the electrode and the substrate from a powder feed channel configured within or at least partially surrounding the electrode.

13. The method of claim 12, wherein a distance between the electrode and the substrate ranges from 20 μm to 200 μm.

14. The method of claim 12, wherein a flow rate of the powder fed into the discharging gap ranges from 1 g/min to 2 g/min.

15. The method of claim 12, wherein a voltage across the discharging gap ranges from 50V to 150V.

16. The method of claim 12, wherein a capacitance for spark discharging ranges from 100 μF to 200 μF.

17. The method of claim 12, wherein the powder is carried by a gas, and a flow rate of the carrier gas ranges from 5 l/min to 15 l/min.

18. The method of claim 12, wherein the powder has a composition different from that of the electrode.
